(19) United States
(12) Patent Application Publication
(10) Pub. No.: US 2002/0027689 A1
(43) Pub. Date: Mar. 7, 2002

(54) Fiber optic transceiver employing front end level control

(76) Inventors: Meir Bartur, Los Angeles, CA (US); Farzad Ghadooshahy, Brentwood, CA (US)

Correspondence Address: David L. Henty, Myers, Dawes & Andras LLP, Suite 1150, 19900 MacArthur Blvd., Irvine, CA, 92612, US

(21) Appl. No.: 09/907,137

(22) Filed: Jul. 17, 2001

Related U.S. Application Data
(60) Provisional application No. 60/230,133, filed on Sep. 5, 2000.

(51) Int. Cl. H04B 10/00; H04B 10/06

(52) U.S. Cl. 359/152; 359/189

(57) ABSTRACT

A fiber optic transceiver operable in a continuous or burst mode is disclosed. The transceiver operating in a receive mode receives modulated light signals and converts the signals to modulated electrical signals. The modulated electrical signals are provided with a front end level control on a bit by bit basis to adjust the signals to a substantially constant reference level. The receiver front end detects also differentiates the signal to provide a signal corresponding to transitions in the incoming modulated electrical signal. The differentiated signal with stable reference level is provided to a quantizer. The quantizer employs the differentiated signal to extract a digital signal which may be accurately used for data and clock signal extraction.

### RELATED APPLICATION INFORMATION

The present application claims priority under 35 USC 119 (e) of provisional application serial no. 60/230,133 filed Sep. 5, 2000 the disclosure of which is incorporated herein by reference.

### BACKGROUND OF THE INVENTION

1. Field of the Invention

The present invention relates to fiber optic transmitters and receivers and related optical networking systems and methods of transmitting and receiving data along optical networking systems.

2. Background of the Prior Art and Related Information

Fiber optic data distribution networks are becoming increasingly important for the provision of high bandwidth data links to commercial and residential locations. Such systems employ optical data transmitters and receivers (or “transceivers”) throughout the fiber optic distribution network. Depending on the specific implementation of the fiber optic network the optical transceivers may operate in a continuous mode or in a burst mode. Also, depending on the specific architecture of the fiber optic network a given receiver may be coupled to receive data from one or a relatively large number of individual transmitters.

Referring to FIGS. 1A and 1B, typical continuous mode and burst mode data transmission patterns are illustrated, respectively. As illustrated in FIG. 1A, in a typical continuous mode data transmission pattern the modulated optical power levels correspond to the encoded data. For example, NRZ (Non Return to Zero) encoding is common in fiber optic distribution networks. In the example of FIG. 1, a high optical power level corresponds to a “1” while a low optical power level corresponds to a “0”, as illustrated in the diagram. Various other encoding techniques may be employed, however, as will be appreciated by those skilled in the art. In any case, in continuous mode transmission the power level corresponding to a high signal will be relatively constant, or at least relatively slowly varying, over time. This allows the receiver to lock onto the optical power levels corresponding to the high and low signals and allows the receiver to relatively easily discriminate the encoded data from the modulated light pulses. Continuous mode transmission may typically be employed where a fiber is not shared by two transmitters or where wavelength division multiplexing is employed to share a fiber.

In FIG. 1B, a representative burst mode data pattern is illustrated corresponding to first and second data bursts provided from the transmitter of a single transceiver. As illustrated a typical data burst or packet comprises a relatively short, high density burst of data. Each burst is typically followed by a relatively long period during which the transmitter is asleep, before the next data burst. During this sleep period another transmitter may be active on the same fiber. Such burst transmission may thus allow multiple transceivers to share an optical fiber on a time division multiple access (TDMA) basis. Also, such burst transmission may allow one receiver to be coupled to receive data from many transmitters on a time multiplexed basis, whether by sharing of a fiber or with separate fibers. For example, burst transmission may be employed in fiber optic data distribution networks which couple a central data distribution transceiver to multiple end user transceivers on a TDMA basis. Also, continuous and burst transmission may be combined in some fiber optic data distribution networks. For example, a central data distribution transceiver may transmit in a continuous mode, e.g., a cable TV signal, whereas the end user transceivers transmit in a burst mode back to the central data distribution transceiver.

Although the use of burst mode transmission, and the combination of burst and continuous mode transmission, has advantages in fiber optic data distribution networks such transmission modes can create problems in data recovery and system costs. The potential problems in data recovery may be appreciated from FIG. 1C. In FIG. 1C, two burst mode data patterns as received at a single receiver are illustrated, the two bursts being respectively provided from first and second transmitters in first and second transceivers. Since the data bursts are provided from different transmitters, the optical power of the two bursts may differ dramatically as illustrated in FIG. 1B. For example, one transmitter may be significantly farther from the receiver than the other transmitter resulting in much lower optical power being received at the receiver. Also , one transmitter may have lower splitting losses than other transmitter located at another node of passive optical splitter. This can also result in significantly different optical power being received from the two transmitters. Also, the transmitters will generally vary within manufacturing tolerances for a given manufacturer and may even be made by different manufacturers. Also, varying age and wear of the transmitters may also result in significantly different optical power being provided from the two transmitters to the receiver.

It will be seen in the example of FIG. 1C that the “0” or low level of the signal of burst 1 is larger than the “1” or high level of the signal of burst 2. When this magnitude difference in optical power is combined with part-to-part offset voltage and temperature variations it will be impossible for the receiver to have a sufficiently constant threshold level for it to decide whether an incoming signal is a one or a zero. Therefore, if the receiver threshold level for data detection is optimized for one transmitter it may lose data transmitted from the second transmitter operating at lower power level. Alternatively, if the receiver is set to discriminate data at the lowest possible power level then data from the higher power transmitter will appear as all ones. Even for less extreme power variations the noise susceptibility is greatly increased. Therefore, undesirably high data errors may result when a single receiver is coupled to multiple transmitters operating in burst mode transmission.

The data recovery problem is further exacerbated due to the high density data requirements of modern optical fiber networks. Recovery of such high density data strains the limits of available circuitry speed. Also, to maximize the potential for TDMA data transmission on a given fiber, bursts may be provided with very short time delays between bursts. For example, a time delay corresponding to only a few bits of data may be provided between consecutive bursts. Therefore, any attempt to optimize receiver data recovery for a given burst must provide the capability to almost immediately adapt to the new optical power from another transmitter in a subsequent burst.

It will be appreciated from the foregoing that the recovery of data in burst transmission systems places significantly greater demands on the receiver than continuous mode transmission system. Nonetheless, in order to provide flexibility in implementing a given fiber optic network using the minimum number of individual electronic comments, it may be desirable to have a receiver capable of operating to detect both continuous mode data transmission and burst mode data transmission. Also, it may be desirable to provide such different modes of operation at a single point in an optical fiber data transmission system but at different times. Therefore, such flexibility provides additional constraints on the ability of the receiver to operate to consistently detect data. Also, it is extremely important to provide these capabilities without significantly increasing the costs of the system.

Accordingly, it will be appreciated that a need presently exists for an optical receiver and/or transceiver capable of efficiently detecting burst mode data transmission from multiple transmitters. It will further be appreciated that a need presently exists for such an optical receiver or transceiver which can provide such efficient data detection without added cost or complexity. It will further be appreciated that a need presently exists for an optical receiver or transceiver capable of operating in both burst and continuous mode.

### SUMMARY OF THE INVENTION

The present invention provides an optical receiver and/or transceiver adapted for use in an optical fiber data transmission system which is capable of efficiently detecting burst mode data transmission from multiple transmitters. The present invention further provides an optical receiver or transceiver which can provide such efficient data detection without added cost or complexity. The present invention further provides an optical receiver or transceiver capable of operating in both burst and continuous mode.

In a first aspect the present invention provides an optical receiver comprising a photo-detector for receiving an input modulated light beam and providing as an output a modulated electrical signal. An amplifier is coupled to the photo-detector output and provides an amplified modulated electrical signal. A quasi-differentiator circuit receives the amplified modulated electrical signal and provides a signal derived from transitions in the amplified modulated electrical signal. A quantizer circuit receives the derived signal and provides a digital signal corresponding to the derived signal.

In a preferred embodiment, the quasi-differentiator circuit comprises a high speed differential amplifier and a high speed integrator. The differential amplifier has first and second inputs and an output, and the integrator is coupled in a feedback configuration from the output to one of said inputs. The integrator also has an input reference voltage which sets a stable reference level for the derived signal. The high speed integrator allows the reference level to be reestablished on a transition by transition basis, which typically corresponds to a single bit timing in the transmitted data. This provides a stable reference level for use by the quantizer even where the input power level changes rapidly, for example, where consecutive bursts have significant power variations. In this way accurate data recovery may be provided even where high data density burst transmission is employed. Advantages may also be provided in receiving continuous mode data transmission or both continuous and burst mode transmission.

In a further aspect the optical receiver of the present invention preferably further includes a hysteresis control circuit. The quantizer circuit includes a hysteresis control input and the hysteresis control circuit is coupled to the hysteresis control input of the quantizer. The hysteresis control circuit includes an optical power monitoring circuit providing an optical power signal related to the input optical power. The hysteresis control circuit employs the monitored optical power to adjust the hysteresis level of the quantizer based on the optical power signal. This provides improved noise resistance and improved data recovery accuracy.

Further features and advantages will be appreciated from a review of the following detailed description of the invention.

### BRIEF DESCRIPTION OF THE DRAWINGS

FIGS. 1A, 1B and 1C are optical power vs. timing diagrams illustrating typical continuous and burst mode data transmission waveforms.

FIG. 2 is a block schematic drawing of a dual fiber fiber optic data transmission system in accordance with the present invention.

FIG. 3 is a block schematic drawing of a single fiber fiber optic data transmission system in accordance with the present invention.

FIG. 4 is a block schematic drawing of a transceiver coupled to dual optical fibers in accordance with the present invention.

FIG. 5 is a block schematic drawing of a transceiver coupled to a single optical fiber in accordance with the present invention.

FIG. 6 is a block schematic drawing of an optical receiver front end in accordance with the present invention.

FIG. 7 is a block schematic drawing of an alternate embodiment of an optical receiver front end in accordance with the present invention employing a manual or automatic hysteresis control circuit.

FIG. 8 is a block schematic drawing of another alternate embodiment of an optical receiver front end in accordance with the present invention employing a received signal strength indicator.

FIG. 9 is a block schematic drawing of another alternate embodiment of an optical receiver front end in accordance with the present invention employing both received signal strength indicator and a manual or automatic hysteresis control circuit.

FIG. 10 is a diagram illustrating two different magnitude input signals provided to the receiver front end of the present invention.

FIG. 11 is a diagram illustrating an input signal provided to the receiver front end of the present invention and a signal output from a quasi-differentiator circuit employed in the receiver front end of the present invention.

FIG. 12 is a diagram illustrating the Quantizer input and output signals in the presence of noise when employed in the receiver front end of the present invention.

FIG. 13 is a diagram illustrating two different magnitude input signals provided to the receiver front end of the present invention and corresponding signals output from a quasi-differentiator circuit employed in the receiver front end of the present invention.

FIG. 14 is a diagram illustrating an input signal provided to the quantizer employed in the receiver front end of the present invention illustrating the effect of noise and two stages of hysteresis which reduces the effect of noise.

FIG. 15 is a schematic drawing of a preferred implementation of a quasi-differentiator circuit employed in the optical receiver front end of the present invention.

FIG. 16 is a schematic drawing of a preferred implementation of a quantizer circuit employed in the optical receiver front end of the present invention.

### DETAILED DESCRIPTION OF THE INVENTION

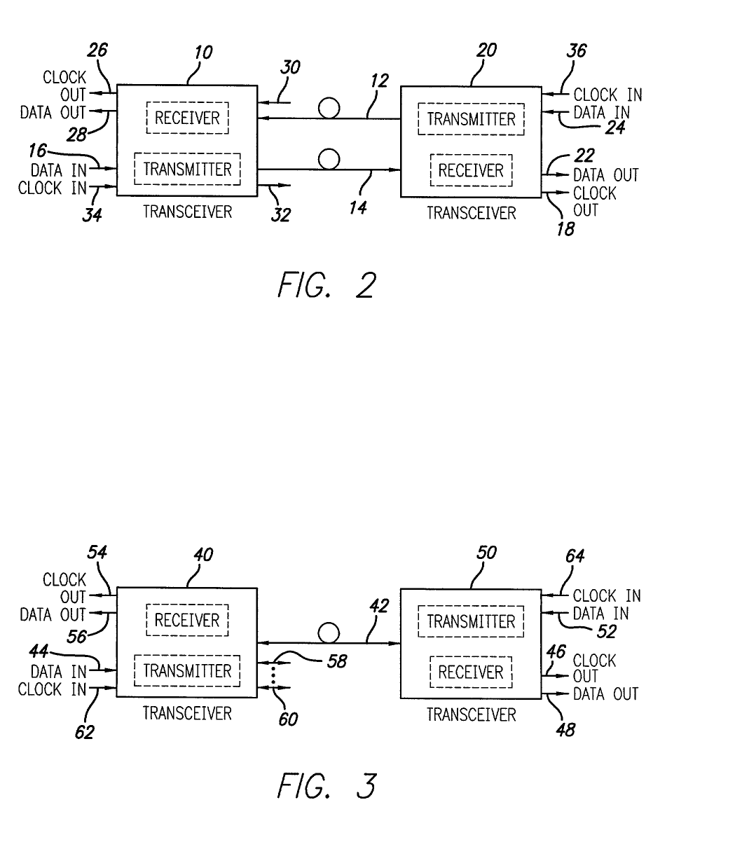

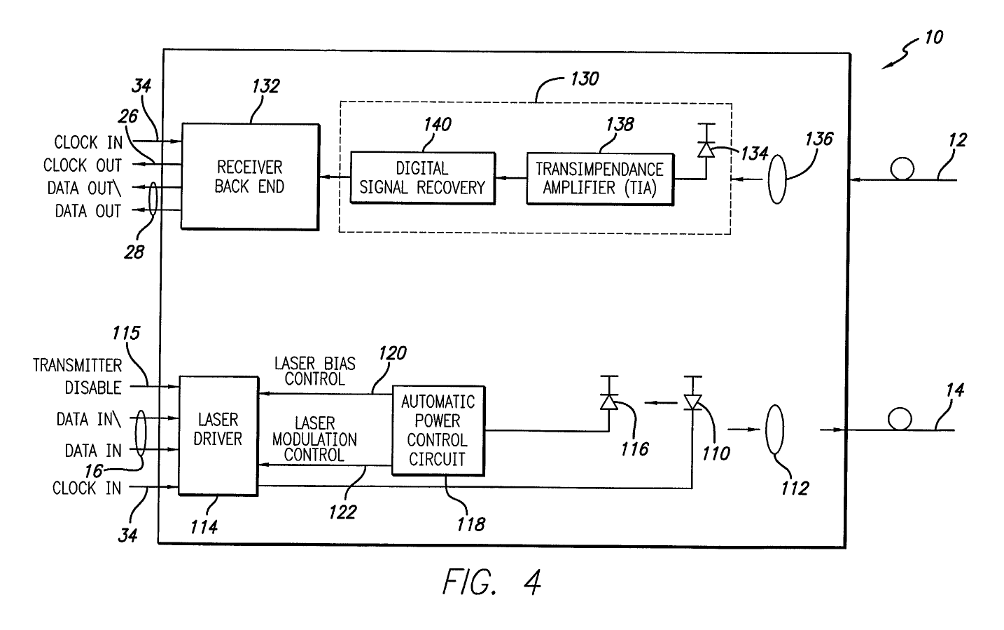

Referring to FIGS. 2 and 3, a high-level block schematic drawing of a fiber optic data transmission system incorporating the present invention is illustrated. FIG. 2 corresponds to a dual fiber data transmission system while FIG. 3 corresponds to a single fiber data transmission system.

Referring first to FIG. 2, a first transceiver 10 is coupled to a second transceiver 20 via first and second optical fibers 12 and 14. As indicated by the arrows on the optical fibers, transceiver 10 transmits data to transceiver 20 in the form of modulated optical light signals along optical fiber 14. The data to be transmitted may be provided to transceiver 10 from an external data source in the form of input electrical data signals along line 16. Transceiver 20 in turn converts the modulated light signals provided along fiber 14 to electrical signals and provides clock and data signals along lines 18 and 22 as illustrated in FIG. 2. Transceiver 20 also receives as an input electrical data signals along line 24 and transmits the data along fiber 12 in the form of modulated light signals to transceiver 10. Transceiver 10 converts the received modulated light signals to electrical signals and provides output clock and data signals along lines 26 and 28, as illustrated. In synchronous systems transceivers 10 and 20 will receive a clock signal along lines 34 and 36, respectively, in which case a clock output along lines 18 and 28 is not necessary.

Both transceiver 10 and transceiver 20 include receiver circuitry to convert optical signals provided along the optical fibers to electrical signals and to detect encoded data and/or clock signals. In various applications data transmission along the optical fibers may be in burst mode or both burst and continuous modes at different times. Also, one fiber may carry data transmitted in burst mode and another in continuous mode. For example, transceiver 10 may transmit data along fiber 14 in a continuous mode whereas transceiver 20 may transmit data back to transceiver 10 along fiber 12 in a burst mode. This configuration may for example be employed in a passive optical network (PON) where transceiver 10 corresponds to an optical line terminator (OLT) whereas transceiver 20 corresponds to an optical networking unit (ONU). In this type of fiber optic data distribution network transceiver 10 may be coupled to multiple optical networking units and this is schematically illustrated by fibers 30 and 32 in FIG. 2. For a PON system, the fibers are combined external to the transceiver. The number of such connections is of course not limited to those illustrated and transceiver 10 could be coupled to a large number of separate optical networking units in a given application, and such multiple connections are implied herein. As will be better appreciated from the following discussion, the present invention provides the capability to detect data transmitted in either burst or continuous mode operation in these various fiber optic network applications.

Referring to FIG. 3, a fiber optic transmission system is illustrated employing a single fiber coupling between transceivers 40 and 50. The operation of the transceivers in FIG. 3 is similar to that described in relation to FIG. 2 with the difference that a bidirectional data transmission is provided along fiber 42. For example, wavelength division multiplexing may be employed. If wavelength division multiplexing is employed transceiver 40 may provide data transmission to transceiver 50 employing a first wavelength of light modulated and transmitted along fiber 42 and transceiver 50 may provide data along fiber 42 to transceiver 40 employing a second wavelength of light. Alternatively transmission in the two directions may be provided in accordance with time division multiplexing or using other protocols. Input electrical data signals may be provided along line 44 from outside data source to transceiver 40 for transmission to transceiver 50 as modulated light signals. Transceiver 50 in turn receives the light pulses, converts them to electrical signals and outputs clock and data signals along lines 46 and 48 respectively. Transceiver 50 similarly receives input electrical data signals along line 52, converts them to modulated light signals and provides the modulated light signals along fiber 42 to transceiver 40. Transceiver 40 receives the modulated light pulses, converts them to electrical signals and derives clock and data signals which are output along lines 54 and 56, respectively. Also, clock inputs along lines 62 and 64 may be provided in a synchronous system. As in the case of the previously described embodiment of FIG. 2, the present invention provides the capability for either burst or continuous mode operation or both at different times. Also, as in the embodiment described above, one or more of transceivers 40 and 50 may be coupled to a plurality of additional transceivers and receive or transmit data to such transceivers along additional fibers 58 and 60, as illustrated in FIG. 3. It will further be appreciated that additional fiber coupling to additional transceivers may also be provided for various applications and architectures and such are implied herein.

Referring to FIG. 4, a block schematic drawing of a transceiver coupled to dual optical fibers in accordance with the present invention is illustrated. The transceiver illustrated in FIG. 4 may correspond to either transceiver 10 or 20 illustrated in FIG. 2 although it is denoted by reference numeral 10 in FIG. 4 and in the following discussion for convenience of reference. The transmitter portion of transceiver 10 may operate in a continuous mode, for example, in an application where the transceiver is an OLT in a fiber optic network. Alternatively, the transmitter may operate in a burst mode, for example, if transceiver 10 is an ONU in a PON fiber optic network. Also, the transmitter may have the capability to operate in both burst and continuous modes at different times. As illustrated, the transmitter portion of transceiver 10 includes a laser diode 110 which is coupled to transmit light into optical fiber 14 via passive optical components illustrated by lens 112 in FIG. 4. Passive optical components in addition to lens 112 may also be employed as will be appreciated by those skilled in the art. Laser diode 110 is coupled to laser driver 114 which drives the laser diode in response to the data input provided along lines 16 to provide the modulated light output from laser diode 110. Various modulation schemes may be employed, for example, NRZ encoding such as described above may be employed as well as other schemes well known in the art. In addition to receiving the data provided along lines 16 the laser driver 114 may receive a transmitter disable input along line 115 as illustrated in FIG. 4. This may be used to provide a windowing action to the laser driver signals provided to the laser diode to provide a burst transmission capability in a transmitter adapted for continuous mode operation to thereby provide dual mode operation. The laser driver 114 may also receive a clock input along line 34 which may be used to reduce jitter in some applications. As further illustrated in FIG. 4, a back facet monitor photodiode 116 is preferably provided to monitor the output power of laser diode 110. The laser output power signal from back facet monitor photodiode 116 is provided to an automatic power control circuit 118 which adjusts a laser bias control input to the laser driver 114 and a laser modulation control input to the laser driver 114, along lines 120 and 122 respectively. Suitable automatic power control circuits are disclosed in copending US Patent Applications entitled “Fiber Optic Transceiver Employing Analog Dual Loop Compensation” to Meir Bartur, Farzad Ghadooshahy, Sean Zargari, and Jim Stephenson, and “Fiber Optic Transceiver Employing Digital Dual Loop Compensation” to Jim Stephenson, filed concurrently herewith, the disclosures of which are incorporated herein by reference. These control signals allow the laser driver 114 to respond to variations in laser diode output power, which power variations may be caused by temperature variations, aging of the device circuitry or other external or internal factors.

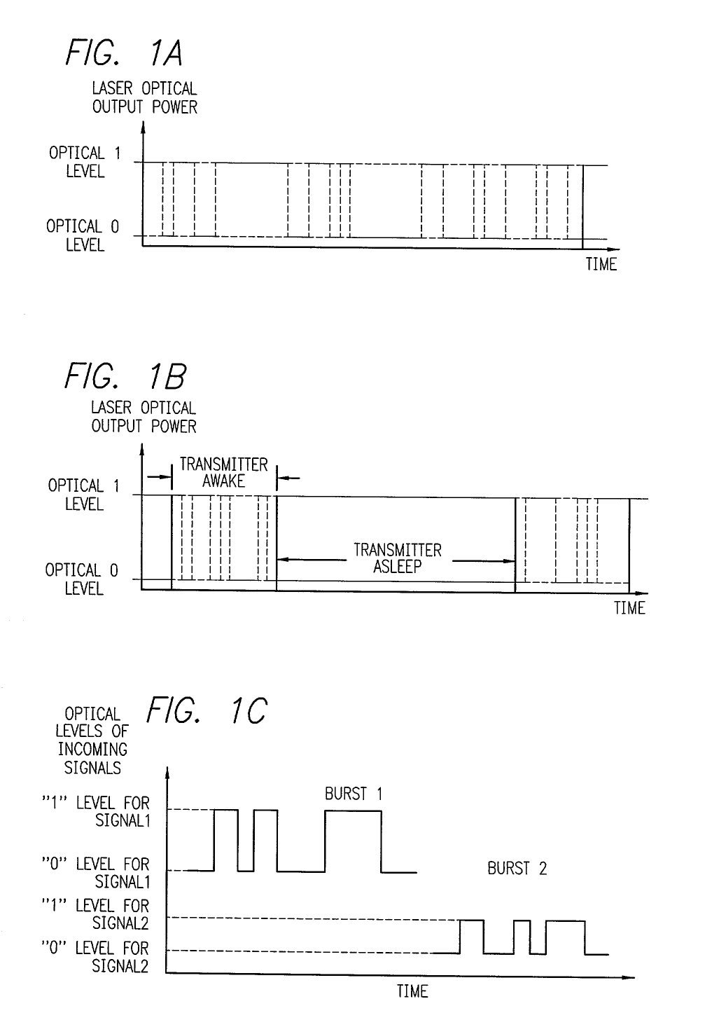

Still referring to FIG. 4, the receiver portion of the transceiver 10 includes a front end 130 and a back end 132. Front end 130 includes a photodetector 134, which may be a photodiode, optically coupled to receive the modulated light from fiber 12. Photodiode 134 may be optically coupled to the fiber 12 via passive optics illustrated by lens 136. Passive optical components in addition to lens 136 may also be employed as will be appreciated by those skilled in the art. The front end 130 of the receiver further includes a transimpedance amplifier 138 that converts the photocurrent provided from the photodiode 134 into an electrical voltage signal. The electrical voltage signal from transimpedance amplifier 138 is provided to digital signal recovery circuit 140 which converts the electrical signals into digital signals. That is, the voltage signals input to the digital signal recovery circuit from transimpedance amplifier 138 are essentially analog signals which approximate a digital waveform but include noise and amplitude variations from a variety of causes. The digital signal recovery circuit 140 detects the digital waveform within this analog signal and outputs a well defined digital waveform, for example, with a shape such as illustrated in FIG. 1A or 1B. The digital signals output from digital signal recovery circuit 140 are provided to the back end of the receiver 132 which removes signal jitter, for example using a latch and clock signal to remove timing uncertainties, and which may also derive the clock signal from the digital signal if a clock signal is not available locally. In the latter case the receiver back end 132 comprises a clock and data recovery circuit which generates a clock signal from the transitions in the digital signal provided from digital signal recovery circuit 140, for example, using a phase locked loop (PLL), and provides in phase differential clock and data signals at the output of transceiver along lines 26 and 28, respectively. An example of a commercially available clock and data recovery circuit is the AD807 CDR from Analog Devices. Also, the receiver back end 132 may decode the data from the digital high and low values if the data is encoded. For example, if the digital signal input to the clock and data recovery circuit is in NRZ format, the clock and data recovery circuit will derive both the clock and data signals from the transitions in the digital waveform. Other data encoding schemes are well known in the art will involve corresponding data and clock recovery schemes. In the case of synchronous systems, such as PON optical networks, the clock may be available locally and the back end 132 aligns the phase of the incoming signal to the local clock, such that signals arriving from different transmitters and having differing phases are all aligned to the same clock. In this case the clock signals are inputs to the receiver back end from the local clock provided along line 34. A suitable clock and data phase aligner for such a synchronous application is disclosed in co-pending US Patent application entitled “Fiber Optic Transceiver Employing Clock and Data Phase Aligner”, to Meir Bartur and Jim Stephenson, filed concurrently herewith.

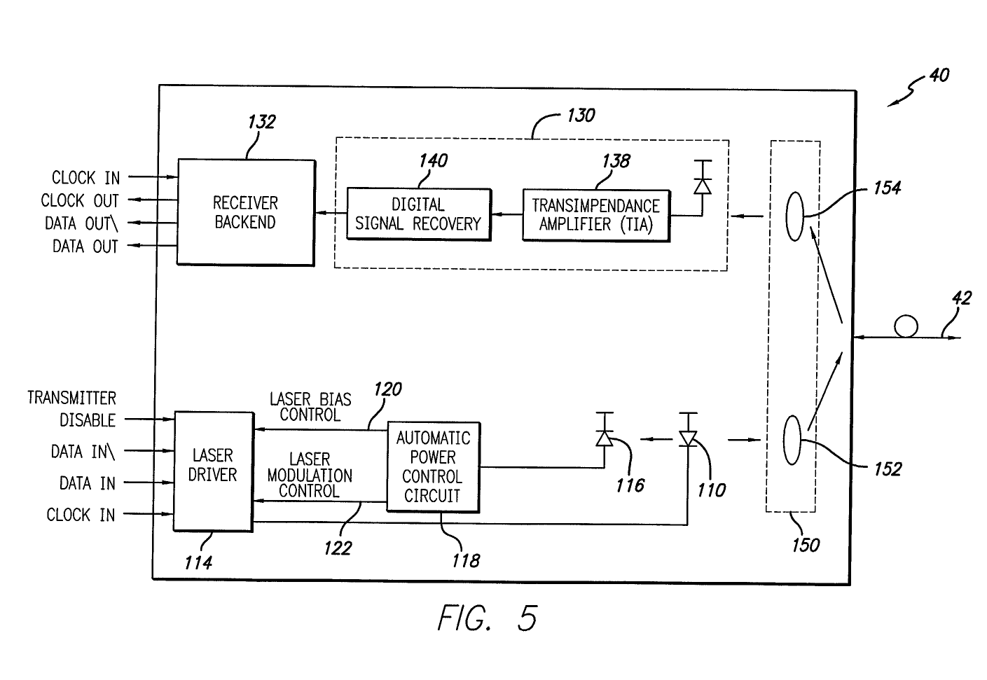

Referring to FIG. 5, transceiver 40 is illustrated corresponding to a single fiber implementation such as discussed above in relation to FIG. 3. The single fiber transceiver 40 includes the same general functional elements as described in relation to transceiver 10 above and like numerals are employed. The single fiber embodiment of FIG. 5 differs from the embodiment of FIG. 4 in that it employs optics 150 adapted to deliver modulated light to fiber 42 from the transmitter portion of transceiver 40 and to provide incoming modulated light from fiber 42 to the receiver portion. The optics 150 is generally illustrated schematically in FIG. 5 by first and second lenses 152,154, however, optics 150 may include filters and beams splitters to separate the wavelengths of light corresponding to the transmit and receive directions in a wavelength division multiplexing implementation of the single fiber transceiver. In a time division multiple access implementation of the single fiber transceiver employing a single wavelength of light, optics 150 may simply include the lenses or other optics to optically couple both the transmit laser diode and the receive photodiode to fiber 42.

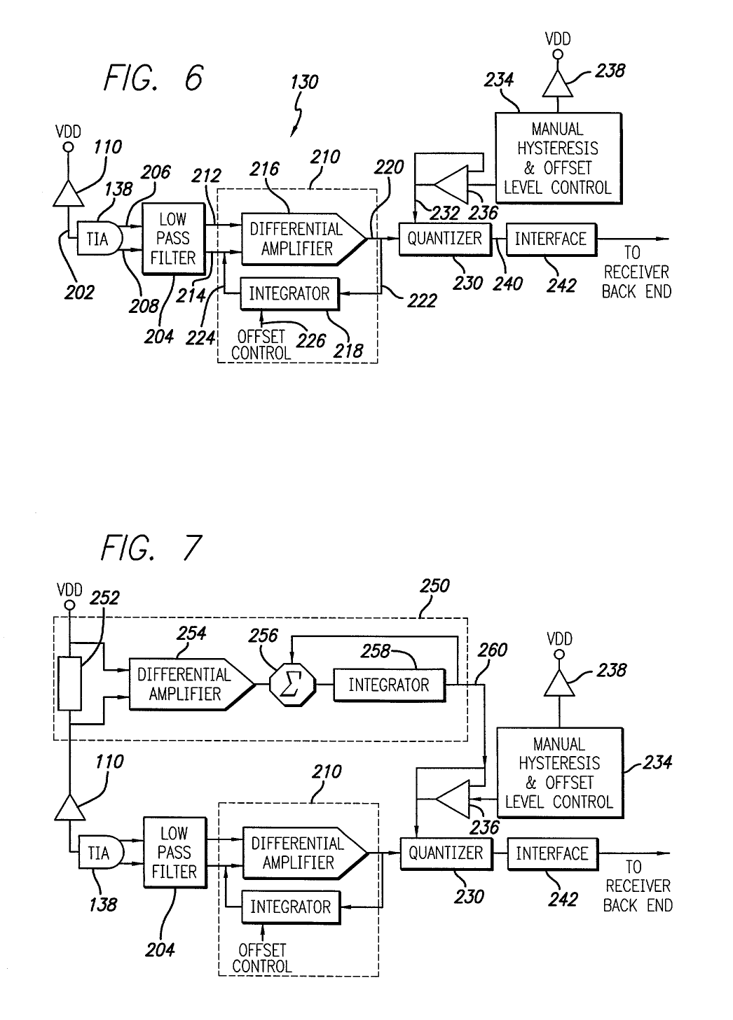

Referring to FIG. 6, a block schematic drawing of preferred embodiment of front end 130 of the receiver portion of the transceiver of the present invention is illustrated. As discussed previously, the present invention provides the capability to receive input modulated light signals which transmit data in burst mode, continuous mode, or both burst and continuous mode of operation.

As shown in FIG. 6, receiver front end 130 includes photodiode 110 which is coupled to a DC power supply voltage, illustrated as VDD, in FIG. 6 and provides an output photocurrent along line 202 corresponding to the incoming modulated light. The output photocurrent provided along line 202 is provided to transimpedance amplifier 138 which converts the photocurrent to a voltage signal. The transimpedance amplifier 138 may be a conventional transimpedance amplifier such as is commercially available from a number of manufacturers. For example, suitable transimpedance amplifiers are available from Philips Semiconductor, e.g. part number TZA3033, and such may be employed for transimpedance amplifier 138. The output of conventional commercially available transimpedance amplifiers typically have a differential output which comprises two identical outputs which are opposite in phase. The differential output improves common mode noise rejection, as will be appreciated by those skilled in the art. Although a differential voltage signal is preferred in most applications due to the improved noise rejection, it should be appreciated that a single output voltage signal may be provided in some implementations. Also, commercially available transimpedance amplifiers typically incorporate automatic gain control circuitry to accommodate a large dynamic range. Such automatic gain control circuitry provides a reduced output voltage as optical power increases. Nonetheless, since an AGC circuit is a relatively slow circuit preferably no such circuit is incorporated into the TIA 138 and if there is AGC incorporated into the TIA it needs to be disabled for the receiver to be used in high density data transmission applications.

The differential output voltage signal from the transimpedance amplifier 138 is provided to low pass filter 204 along lines 206 and 208, as illustrated in FIG. 6. Low pass filter 204 limits the bandwidth of the voltage signal and converts the incoming signal into a cleaner output signal. This filtering will thus improve the signal-to-noise ratio and provide reduced ringing on the transition edges. A suitable filter which may be employed for filter 204 is a three pole passive Bessel filter. Suitable circuits implementing such a filter are known in the art and are commercially available and such may be employed for filter 204.

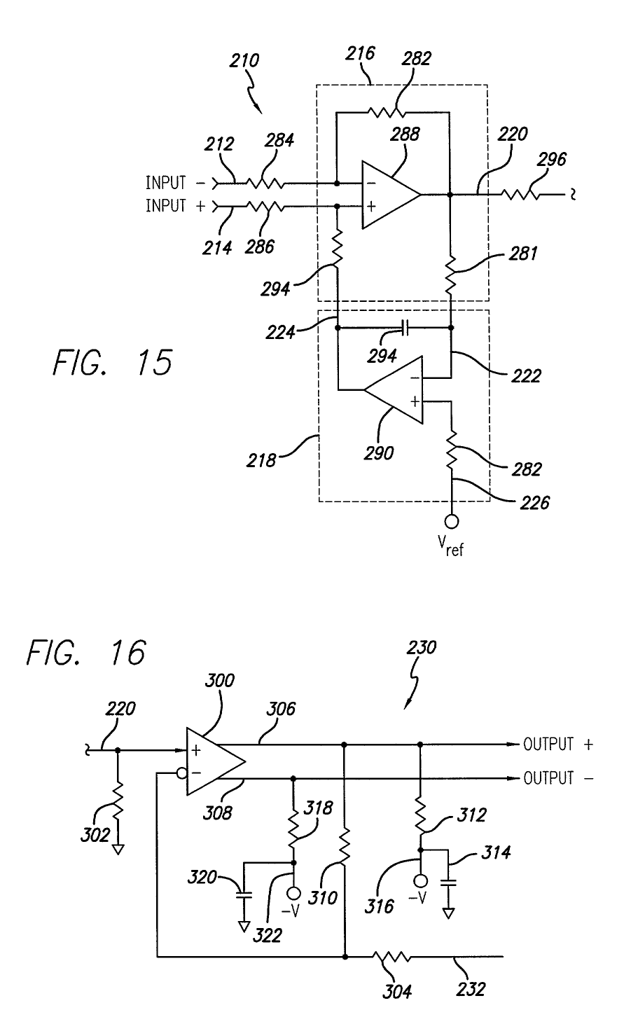

The filtered differential output from low pass filter 204 is provided to quasi-differentiator circuit 210 along lines 212 and 214 as illustrated in FIG. 6. The quasi-differentiator circuit 210 operates to convert the incoming modulated electrical signal to a signal derived from the transition edges in the incoming signal. The quasi-differentiator circuit 210 also operates to maintain the level of the derived signal to a substantially constant reference level despite variations in the input which may be due to significant to variations in consecutive bursts, such as described above in relation to FIG. 1C. As illustrated in FIG. 6, in a preferred implementation, the quasi-differentiator circuit 210 comprises a highspeed differential amplifier (HSDA) 216 and an high speed integrator 218 coupled to feedback the output of differential amplifier 216 to an input thereof. More specifically, the differential amplifier 216 may comprise a high frequency operational amplifier which converts the differential incoming signal provided along lines 212, 214 into a single ended output signal provided along line 220. In the process of conversion, common mode AC or DC components are eliminated from the incoming signal. The integrator 218 is a circuit which implements the mathematical operation of integration of the voltage signal input thereto along line 222. Integrator 218 provides the integrated output along line 224 to one of the differential inputs to differential amplifier 216, as illustrated in FIG. 6. Integrator 218 also includes an offset control input provided along line 226 which control may be used to adjust the circuit reference voltage for the particular implementation of the device. Integrator 218 is implemented as a high-speed circuit and may comprise a high gain operational amplifier and a negative feedback circuit. A suitable implementation of quasi-differentiator circuit 210 employing high-speed differential amplifier 216 and the integrator 218 is described below in relation to FIG. 15. Generally due to the lack of AGC the combination of the differential amplifier 216 and the integrator 218 could operate from dual power supplies to increase the linear dynamic range of the receiver front end.

Still referring to FIG. 6, the output of the quasi-differentiator is 210 provided along line 220 to a quantizer circuit 230. Quantizer circuit 230 operates on the input voltage signal to distinguish whether the input signal is a high or low level (or logical 1 or a logical 0) even in the presence of noise. Since the output from the quasi-differentiator circuit 210 is provided with a stable reference level and with a signal waveform corresponding to transitions for any modulated input signal the operation of quantizer 230 will be substantially improved, especially with respect to an input signal having significant amplitude variations on a burst to burst or even bit to bit basis. A suitable implementation of quantizer 230 will be described below in relation to FIG. 16. Incorporated in a preferred implementation of the quantizer 230 is a hysteresis circuit which ensures the stability of the device. The operation of the hysteresis circuitry in quantizer 230 may be adjusted by an input provided along line 232 as illustrated in FIG. 6. The control signal provided along line 232 may be controlled by a manual hysteresis and offset level control circuit 234 which may be manually adjusted to adjust the hysteresis control provided to quantizer 230 for the specific implementation or over time due to aging of the circuitry, etc. The manual hysteresis and offset level control circuit 234 is coupled from a voltage reference diode 238 which provides an stable voltage reference level to the manual hysteresis and offset level control circuit 234. Such components are commercially available like the LM185-1.2 part from National semiconductor Inc. The hysteresis control circuitry may further include a feedback coupled differential amplifier 236, also coupled to receive the output from the manual hysteresis and offset level control circuit 234 as a second differential input, which acts as a buffer to stabilize the hysteresis control signal provided to the quantizer 230. The output from the quantizer circuit 230 is a digital signal having a sequence of constant amplitude high and low (or logical 1 and logical 0) values corresponding to the input light signals. This digital signal is output along line 240 as illustrated in FIG. 6.

Still referring to FIG. 6, the output from the quantizer circuit 230 is provided along line 240 to an interface circuit 242. Interface circuit 242 converts the digital signal provided along line 240 to an appropriate logic signal for use by the receiver back end. For example, the interface 242 may convert the digital signal provided along line 240 to PECL, ECL, or TTL logic signals depending on the particular logic implementation adapted for the receiver back end. As will be appreciated by those skilled in the art other logic interface protocols are also possible and interface 242 may be adapted for such particular logic employed in the receiver back end.

Referring to FIG. 7, a block schematic drawing of an alternate embodiment of an optical receiver front end in accordance with the present invention is illustrated employing a manual or automatic hysteresis control circuit 250. The manual or automatic hysteresis control can be done by monitoring optical power or use of a system level diagnostics such as bit error rate measurement (BER) or some type of algorithm based implementations. The portions of the circuitry in the embodiment illustrated in FIG. 7 which may correspond to the previously described embodiment are labeled with like numerals and for brevity the operation thereof will not be described again in relation to the embodiment of FIG. 7.

The preferred implementation of the hysteresis control circuit 250 includes an optical power monitoring resistor 252 coupled in series between the photodiode 110 and the power supply voltage VDD. The optical power monitoring resistor 252 provides a voltage level across it that is proportional to the incoming optical signal level. This voltage drop across the resistor 252 is provided to differential amplifier 254. The output of the differential amplifier 254, which is an amplified signal corresponding to the voltage drop across the monitoring resistor, is provided to an averaging circuit which may preferably comprise a summing junction 256 and an integrator 258 which is feed back coupled to the summing junction 256. The output of the averaging circuit is a DC voltage level corresponding to the average output voltage measured across the optical power monitoring resistor 252. This averaged signal is provided along line 260 to the hysteresis setting control input to the quantizer circuit 230. This averaged instantaneous optical power signal may be summed with the manual hysteresis control signal which combined signal is used to adjust the hysteresis setting on an ongoing basis to improve the ability of quantizer 230 discriminate the data in the incoming signal.

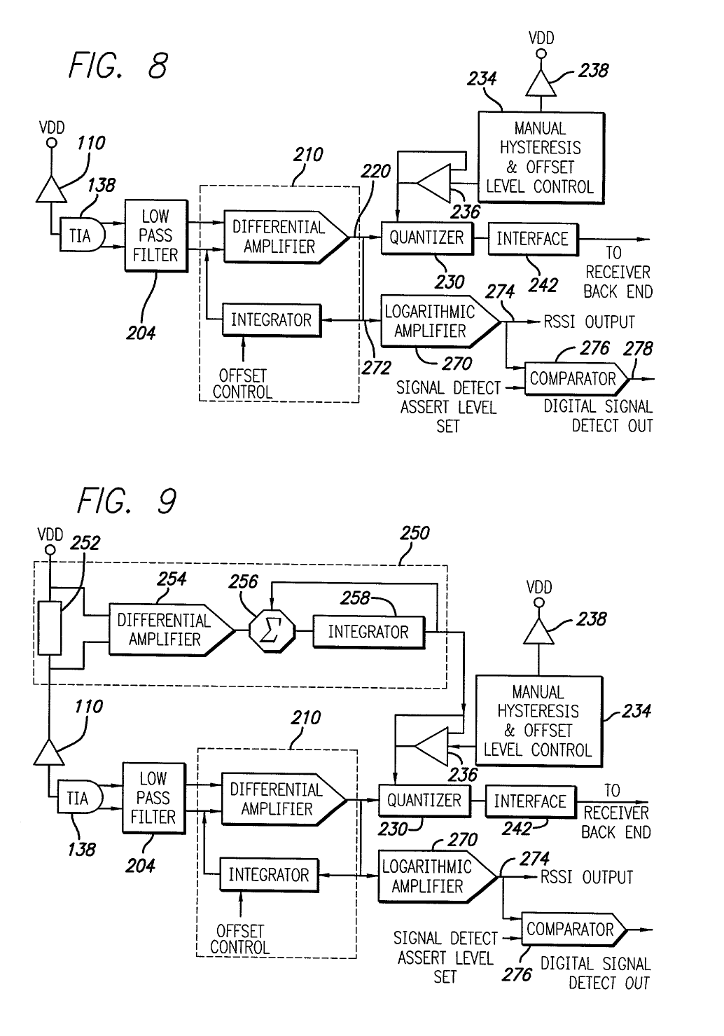

Referring to FIG. 8, a block schematic drawing of another alternate embodiment of an optical receiver front end in accordance with the present invention employing a received signal strength indicator (RSSI) is illustrated. The portions of the circuitry in the embodiment illustrated in FIG. 8 which may correspond to the previously described embodiments are labeled with like numerals and for brevity the operation thereof will not be described again in relation to the embodiment of FIG. 8. As shown in FIG. 8, the RSSI circuitry includes logarithmic amplifier 270 which receives as an input the output from the quasidifferentiator circuit 210 along line 272. The logarithmic amplifier 270 detects the signal provided along line 272 and provides a DC voltage output along line 274 which corresponds to the actual received signal level. Preferably the logarithmic amplifier has a fast response time so that it can detect signal levels from the incoming packets in a burst mode of operation before the next incoming packet interferes with the detected result provided along line 274. Suitable high speed logarithmic amplifiers are commercially available, for example, from Burr-Brown Corp., part no. VCA610. This DC output voltage on line 274 is provided as a RSSI output signal. The RSSI illustrated in FIG. 8 is thus an “In Packet” received signal strength indicator or IPRSSI since it indicates the actual input signal level of the optical signal within a packet. This has several benefits; for example, since the output RSSI signal is an indication of signal content of the transmitted optical signal, this information may be used for troubleshooting the transmitter or simply informing the transmitter to control its optical output power.

Still referring to FIG. 8, also incorporated in the receiver is a digital signal detect output, which generally provides an output corresponding to the sensitivity level of the receiver. This is provided by comparator 276 which receives the DC output of the amplifier 270 as one input thereto and a signal detect reference signal at the other input. For example, comparator 276 may detect when the incoming signal strength exceeds a predetermined minimum reference and provides a digital signal detect output along line 278 indicating a sufficiently strong signal for receiver operation. Alternatively, the comparator may be set to provide a warning signal if the signal input strength falls below a minimum level for receiver operation.

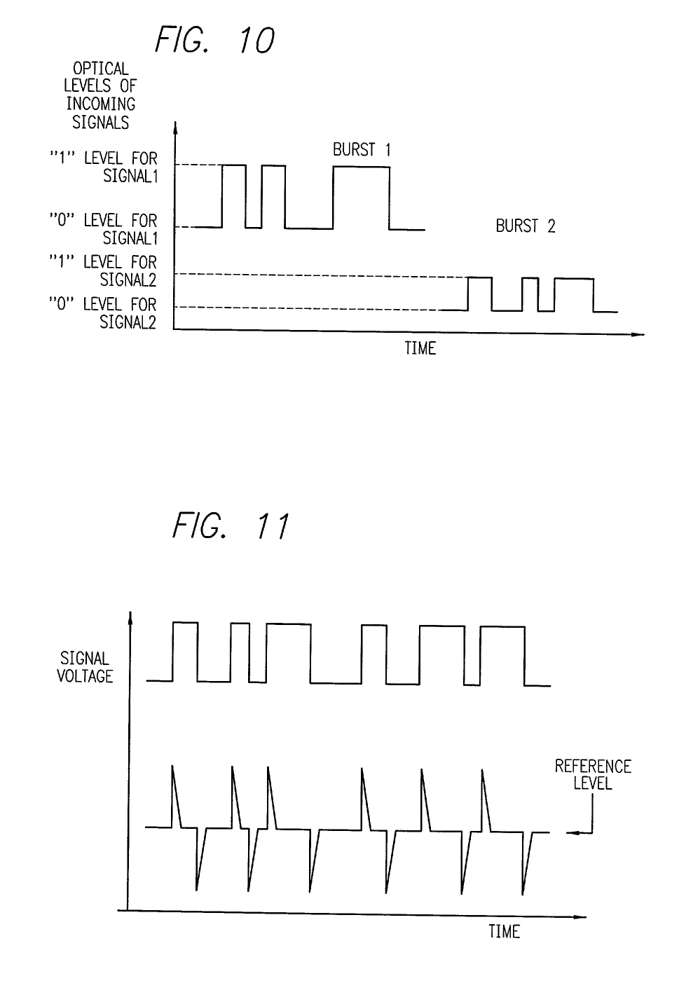

Referring to FIG. 9, a block schematic drawing of an embodiment of the present invention incorporating the front end receiver capabilities described in relation to FIGS. 6, 7 and 8 above is illustrated. The illustrated embodiment simply combines the features described above and like numerals are employed for the like components. Accordingly, a detailed discussion of the embodiment of FIG. 9 is unnecessary as the features operate as described above. Since the embodiment of FIG. 9 combines the above described features it may be preferred in applications where high-performance is desired.

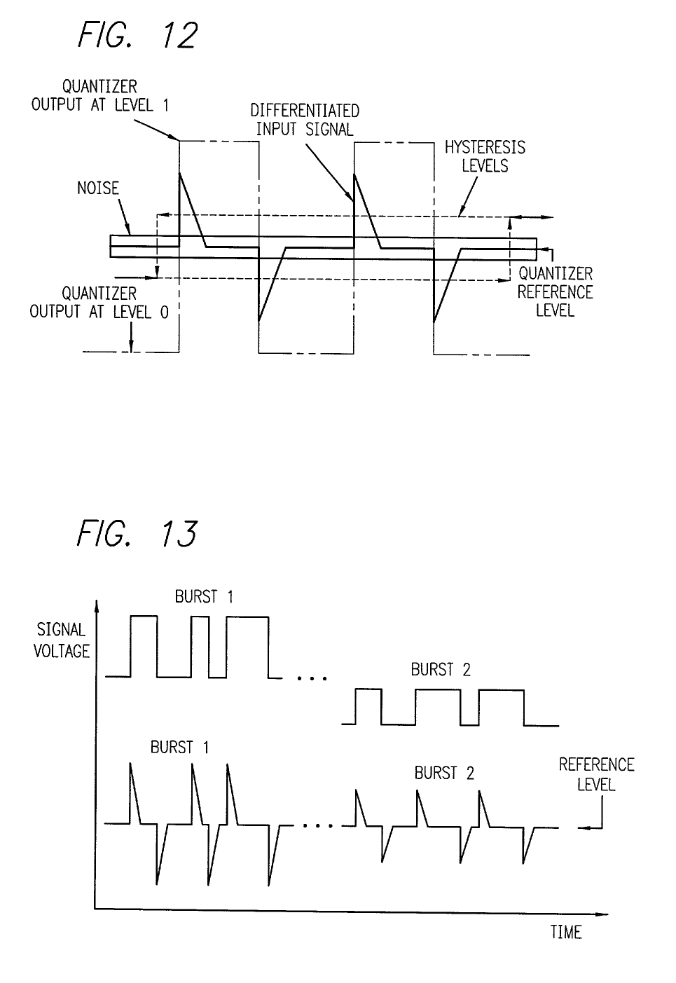

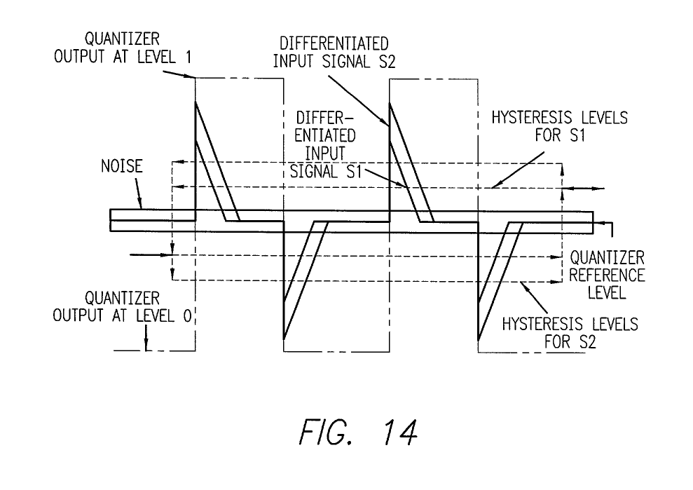

With reference to FIGS. 6, 10, 11, 12 and 13 the operation of the receiver front end of FIG. 6 and the associated method of the present invention will be described in relation to both a burst mode and continuous mode input signal. FIG. 10 is a diagram illustrating two different magnitude input signals, corresponding to two different bursts from two different transmitters, as provided to the receiver front end of the present invention. FIG. 11 is a diagram illustrating in the upper portion an input signal provided to the receiver front end of the present invention corresponding to a single burst (or continuous mode signal) and in the lower portion the signal output from the quasi-differentiator circuit employed in the receiver front end of the present invention. FIG. 12 is a diagram illustrating an input signal provided from the quasi-differentiator to the quantizer employed in the receiver front end of the present invention, and the quantizer output waveform. FIG. 13 is a diagram illustrating in the upper portion two different magnitude input signals provided to the receiver front end of the present invention and in the lower portion corresponding signals output from the quasi-differentiator circuit employed in the receiver front end of the present invention.

In operation, the photodiode 110 of FIG. 6 converts the optical power either in burst mode or continuous pattern to electrical signal current and the TIA 138 converts the current into differential voltages at its output. The high-speed differential amplifier (HSDA) 216 combines the two differential signals into one single ended output and cancels any common mode AC or DC voltages. As is shown in FIG. 10, each incoming burst or optical packet is in general at a different power level (at the input of the photodiode) and the outputs of the TIA and HSDA will have different amplitude and DC offset levels from packet to packet. The example of FIG. 10 corresponds to that of FIG. 1C discussed above and the “0” level of the signal of burst 1 is larger than the “1” level of the signal of burst 2. As discussed in relation to FIG. 1C, when this optical power magnitude difference is combined with part-to-part offset voltage and temperature variations it would typically be impossible for a conventional receiver front end to be able to accurately determine whether an incoming signal is a one or a zero. In accordance with the present invention, the combination of the HSDA 216 and integrator 218 configured in a feedback loop, results in differentiation of the incoming signal. Also inherently the output DC voltage level of the amplifier 216 will be fixed to a stable reference voltage, regardless of the incoming input signal amplitude or DC offset level. However, due to the speed of the integrator, circuit 210 really behaves as “quasi-differentiator”. Other forms of quantizers are possible if higher data rates are required.

More specifically, a portion of the output of the HSDA 216 will be sampled and fed into the fast integrator 218 which measures the composite DC voltage of the signal and compares it with a given reference voltage. If there is difference between the reference signal DC level and the output signal DC level an error correction signal will be applied to a differential input port of the HSDA 216 via the output of the fast integrator 218. For example, if the DC level at the output of the HSDA 216 is too high or too low compared to the reference level, the integrator output rapidly reduces it or increases it to the reference level. The differentiation aspect of circuit 210 serves to distinguish transitions in the incoming signal as may be appreciated from FIG. 11 which idealizes the incoming signals as square pulse trains for ease of illustration and explanation. After the rising edge of the pulse is detected the integrator will rapidly force the pulse to ramp down, as illustrated in FIG. 11. The signal will then be held at the reference level until the down transition, at which time the fast integrator drives the signal rapidly back up to the reference level. This ideally causes a “differentiation” of the signal. As a result, the output derived signal approximately represents the rising edge and the falling edge of the input signal referenced above and below the reference voltage, respectively. When different packets with different optical power levels arrive to the input of the receiver, as shown in the top portion of FIG. 13, the output of the quasi-differentiator circuit 210 which is provided to the quantizer will have differentiated pulses with a fixed reference DC level, but different peak to peak levels, as shown in the bottom of FIG. 13. This will enable the quantizer to have a fixed threshold setting substantially improving quantizer performance. To have complete differentiation throughout the signal bandwidth the integrator response time should be equal to or less than the fastest rate “one bit time duration T” of data, e.g., the bit timing associated with an NRZ, RZ or other coding of the input signal. Even though it is possible to make very fast integrators it may not be practical for very high data rates or where component costs are a factor. This is due to the lack of readily available very fast voltage feedback op amps and the overshoot on the impulse response of the integrator, with the result that the differentiator circuit only differentiates at the lower data rates. The differentiator will then behave as a high pass filter during higher data rates. Since the differentiator performance is thus selective based on the incoming signal data rate it is referred to herein as a “quasi-differentiator”.

Referring next to FIGS. 6 and 12, operation of the quantizer 230 will be described. As described above, the output of quasi-differentiator circuit 210 provided along line 220 in FIG. 6 to quantizer 230, will have a common DC voltage reference but different amplitude for all incoming burst packets, even with different input signal levels and DC levels. Due to the common DC voltage reference it is now possible to select a fixed stable reference to quantize the data. Using a fast comparator with a set value hysteresis and a given fixed reference level will enable the already “differentiated” signal to be converted back into digital levels which would have a fixed high or low value (or logic “1” or “0”). More specifically, referring to FIG. 12, if the signal level is larger than the high-level reference voltage, which is provided as an input of the quantizer circuit, the output will be switched to the digital level high state, and will stay high as long as the input signal is equal or larger than the high voltage reference minus the hysteresis voltage. The opposite will occur as the input signal level becomes smaller than the low-level reference voltage at the input of the quantizer circuit. The output will switch to the low logic level state, and will stay low as long as the input signal is equal or less than the low voltage reference plus the hysteresis voltage. The hysteresis level is preferably set such that it is larger than the peakto-peak noise and less than half of the minimum peak to peak input signal levels. This assures substantially error free data recovery even in the presence of noise.

Referring next to FIGS. 7 and 14, operation of the alternate embodiment of the present invention employing manual or automatic hysteresis control will be described. Since the peak-to-peak hysteresis level is set such that its level is set to half of the minimum peak to peak input signal levels it would be beneficial to be able to adjust such level to maximize the dynamic range of the overall receiver to prevent saturation and improve noise immunity. This is provided by the hysteresis control circuit 250 of FIG. 7 which provides a DC output voltage along line 260 which corresponds to averaged input optical power. This voltage is summed with the existing hysteresis setting to control the hysteresis of the quantizer 230. Therefore, at the lower signal levels the hysteresis peak to peak level may be set to half of the signal level, and as the signal amplitude increases the hysteresis peak to peak level will increase correspondingly. This is shown in FIG. 14 where the signal S1 has a lower peak to peak hysteresis than the S2 signal hysteresis level, due to the higher power of the signal S2. The hysteresis control of the receiver in accordance with the present invention will thus improve the noise resistance and improve the dynamic range of the receiver substantially. As is shown in FIG. 14 the integration time constant should be constant thus the larger input signal S2 will take a longer time for the output of the differentiator to converge to the reference voltage than the Signal S1. This is due to the gain, slew rate of the (HSDA) 216 and time constant of the Integrator 218. Also the integrator performance at high frequencies is affected by finite bandwidth of the operational amplifier, while at low frequencies the integration is limited by finite gain of the Operational amplifier.

Referring to FIG. 15, a schematic drawing of a preferred embodiment of quasi-differentiator circuit 210 is illustrated. As discussed above in relation to FIG. 6, the quasi-differentiator circuit 210 includes a differential amplifier 216 and a fast integrator 218. The differential amplifier 216 may comprise a high-speed differential amplifier 288 with a feedback resistor 282 coupled between the output of the amplifier and one of the differential inputs. The input values provided along lines 212 and 214 may be adjusted for the particular application during initial circuit design by adding input resistors 284 and 286 as illustrated. As further illustrated in FIG. 15, the fast integrator includes a second high-speed differential amplifier 290 which receives the output from amplifier 288 to a first input thereof along line 222 and resistor 281 and the second input is coupled to a reference voltage Vref via line 226 and resistor 282. A parallel feedback coupled capacitor 294 is also provided to the first input of amplifier 290 and the amplifier output is provided to the second input to high-speed differential amplifier 288 along line 224 via resistor 294. The output of quasi-differentiator circuit 210 is provided along line 220 via optional resistor 296. It will be appreciated by those skilled in the art that the implementation illustrated in FIG. 15 provides the desired characteristics of the quasi-differentiator circuit 210 described in detail above.

Referring to FIG. 16 a schematic drawing of a preferred implementation of a quantizer circuit employed in the optical receiver front end of the present invention is illustrated. The quantizer circuit 230 may employ a high-speed comparator circuit 300 as illustrated. For example, suitable high-speed comparator circuits are commercially available from a number of manufacturers such as Maxim Corp., e.g. as part number MAX 9690. One of the differential inputs to comparator circuit 300 is provided from the quasi-differentiator circuit 210 along line 220 as illustrated. A voltage adjusting resistor 302 coupled to ground may also be provided as illustrated as a matching circuit . The second differential input to comparator circuit 300 is provided from the hysteresis control circuitry along line 232 and is optionally adjusted with a resistor 304 as illustrated. As also illustrated, the comparator circuit 300 has differential outputs provided along lines 306 and 308. The output along line 306 may be fed back to the second differential input of comparator circuit 300 along line 232 and resistor 310 as illustrated. The comparator circuit 300 output along line 306 may also be coupled via resistor 312 to capacitor 314 and ground and to a reference voltage −V along line 316. The second differential output from amplifier 300 along line 318 is coupled through resistor 318 to a second capacitor 320 and ground and to a reference voltage −V along line 322 as illustrated. It will be appreciated by those skilled in the art that the particular embodiment illustrated in FIG. 16 provides a suitable implementation of a quantizer circuit which provides hysteresis as discussed above.

In view of the foregoing detailed description of preferred embodiments of the present invention, it will be appreciated that the present invention provides an optical receiver and/or transceiver adapted for use in an optical fiber data transmission system which is capable of efficiently detecting burst mode data transmission from multiple transmitters. The present invention further provides an optical receiver or transceiver which can provide such efficient data detection without added cost or complexity. The present invention further provides an optical receiver or transceiver capable of operating in both burst and continuous mode.

Although the present invention has been described in relation to specific embodiments it should be appreciated that the present invention is not limited to these specific embodiments as a number of variations are possible while remaining within the scope of the present invention. In particular, the specific circuit implementations illustrated are purely exemplary and may be varied in ways too numerous to enumerate in detail. Accordingly they should not be viewed as limiting in nature.

What is claimed is:

1. An optical receiver, comprising:
a photo-detector for receiving an input modulated light beam and providing as an output a modulated electrical signal;
an amplifier coupled to the photo-detector output and providing an amplified modulated electrical signal;
a quasi-differentiator circuit receiving the amplified modulated electrical signal and providing a signal derived from transitions in the amplified modulated electrical signal; and
a quantizer circuit receiving the derived signal and providing a digital signal corresponding to the derived signal.

2. An optical receiver as set out in claim 1, wherein said amplifier comprises a transimpedance amplifier DC coupled to the photo-detector.

3. An optical receiver as set out in claim 1, wherein said quasi-differentiator circuit comprises a differential amplifier, having first and second inputs and an output, and an integrator coupled in a feedback configuration from the output to one of said inputs and having an input reference voltage.

4. An optical receiver as set out in claim 1, wherein the input modulated light beam is provided in burst or continuous mode.

5. An optical receiver as set out in claim 4, wherein consecutive bursts of modulated light have substantially different optical power and wherein the quasi-differentiator provides the signal derived from transitions from consecutive bursts with a substantially constant reference level.

6. An optical receiver as set out in claim 5, wherein the bursts comprise a plurality of bits of data and wherein the quasi-differentiator circuit adjusts the reference level on a bit timing basis.

7. An optical receiver as set out in claim 1, further comprising a receiver back end coupled to the quantizer circuit and receiving the digital signal therefrom and providing clock aligned data signals derived from the digital signal.

8. An optical receiver as set out in claim 1, wherein the quantizer circuit comprises a hysteresis control input.

9. An optical receiver as set out in claim 8, wherein the optical receiver further comprises an automatic or manual hysteresis control circuit coupled to the hysteresis contol input of the quantizer.

10. An optical receiver as set out in claim 9, wherein the hysteresis control circuit comprises an optical power monitoring circuit providing an optical power signal related to the input optical power and wherein the hysteresis control circuit adjusts the hysteresis level of the quantizer based on the optical power signal.

11. An optical receiver as set out in claim 1, further comprising a received signal strength circuit coupled to the output of the quasi-differentiator and providing an output analog signal corresponding to the received signal strength.

12. An optical transceiver, comprising:
a transmitter comprising a laser diode providing modulated optical signals and a laser driver coupled to a data input and providing a drive signal to the laser diode corresponding to the input data; and
a receiver comprising a front end coupled to receive input modulated light from an optical fiber and providing a corresponding digital electrical signal and a back end coupled to receive the digital electrical signal and provide output data signals, the front end comprising:
a photo-detector for receiving the input modulated light and providing as an output a modulated electrical signal;
an amplifier coupled to the photo-detector output and providing an amplified modulated electrical signal; and
a digital signal recovery circuit receiving the amplified modulated electrical signal and deriving a signal from transitions in the received modulated electrical signal, the derived signal referenced to a reference level on a transition by transition basis, and detecting the digital signal from the derived signal.

13. An optical transceiver as set out in claim 12, wherein said digital signal recovery circuit comprises a quasi-differentiator circuit and a quantizer circuit.

14. An optical transceiver as set out in claim 13, wherein said quasi-differentiator circuit comprises a differential amplifier, having first and second inputs and an output, and an integrator coupled in a feedback configuration from the output to one of said inputs and having an input reference voltage which sets said reference level.

15. An optical transceiver as set out in claim 13, wherein said front end further comprises a hysteresis control circuit which comprises an optical power monitoring circuit providing an optical power signal related to the input optical power and wherein the hysteresis control circuit adjusts the hysteresis level of the quantizer based on the optical power signal.

16. A burst mode optical data transmission system, comprising:
a plurality of transmitters providing burst mode modulated optical signals;
at least one optical fiber optically coupled to the transmitters; and
a receiver optically coupled to the fiber and receiving the burst mode modulated optical signals, the receiver comprising:
a photo-detector for receiving an input modulated light beam and providing as an output a modulated electrical signal;
an amplifier coupled to the photo-detector output and providing an amplified modulated electrical signal;
a quasi-differentiator circuit receiving the amplified modulated electrical signal and providing a signal derived from transitions in the amplified modulated electrical signal; and
a quantizer circuit receiving the derived signal and providing a digital signal from the derived signal.

17. A method for transmitting data between transmit and receive locations over an optical network in a burst mode, comprising:
providing modulated light to an optical fiber at the transmit location in bursts, the bursts comprising a plurality of data bits;
receiving the modulated light from the optical fiber at the receive location;
converting the received modulated light to a modulated electrical signal;
deriving an electrical signal from transitions in the received modulated electrical signal, the derived electrical signal referenced to a reference level on a transition by transition basis; and
providing a digital signal from the derived electrical signal.

18. A method for transmitting data between transmit and receive locations over an optical network as set in claim 17, wherein providing a digital signal comprises quantizing the derived signal employing hysteresis.

19. A method for transmitting data between transmit and receive locations over an optical network as set out in claim 17, further comprising receiving a clock signal and deriving in phase digital data from the digital signal.

20. A method for transmitting data between transmit and receive locations over an optical network as set out in claim 17, wherein deriving an electrical signal corresponding to transitions comprises differentiating the electrical signal over at least a portion of the signal bandwidth.
